(19) United States
(12) Patent Application Publication
(10) Pub. No.: US 2003/0101130 A1
(43) Pub. Date: May 29, 2003

(54) Apparatus and method for designing a market mechanism

(76) Inventor: David Trevor Cliff, Bristol (GB)

Correspondence Address: HEWLETT-PACKARD COMPANY, Intellectual Property Administration, P.O. Box 272400, Fort Collins, CO, 80527-2400, US

(21) Appl. No.: 10/305,462

(22) Filed: Nov. 26, 2002

(30) Foreign Application Priority Data
Nov. 29, 2001 (GB) 0128562.6

(51) Int. Cl. G06F 17/60

(52) U.S. Cl. 705/37; 705/1; 705/10

(57) ABSTRACT

Computer apparatus comprising a processor for being arranging as a number of artificial trading agents; the processor being arranged to define a space of possible market mechanisms; the processor being arranged to select a market mechanisms within the continuum of market mechanisms using a optimisation algorithm to provide optimisation of a market dynamic for the artificial trading agents.

### TECHNICAL FIELD

The present invention relates to an apparatus and method for designing a market mechanism.

### BACKGROUND

Automated trading agents (e.g. software agents or ‘robots’) use simple machine learning techniques to adapt to operating as buyers or sellers in open-outcry auction-market environments, as used in “Experimental study of competitive market behaviour” Journal of Political Economy 70:111-137, 1962.

The operation of automated trading agents has been successfully demonstrated in experimental versions of continuous double auction (CDA) markets similar to those found in the international markets for commodities, equities, capital, and derivatives; and in posted-offer auction markets similar to those seen in domestic high-street retail outlets, as also described in “Experimental study of competitive market behaviour” Journal of Political Economy 70:111-137, 1962. Additionally, research has shown that automated trading agents can consistently out perform human traders in human-against-robot experimental economics marketplaces, as described in “Agent-human interactions in the continuous double auction” Proceedings of the International Joint Conference on artificial intelligence (IJCAI-01), 2001.

In any economic market there are typically a number of parameters that determine the adaptation and trading processes of an automated trading agent (e.g. maximum bid price or minimum sale price). First generation automated trading agents required that these parameter values be set by hand, using “educated guesses”. However, more recently a standard genetic algorithm (GA) has been used to automatically optimise these market parameter values, thereby eliminating the need for a skilled human to input “educated guesses”, see “Genetic Optimization of Adaptive Trading Agents for Double-Auction Markets'” in Proceedings of the 1998 Conference on Computational Intelligence for Financial Engineering (CIFEr98) IEEE/IAFE/Informs (preprint proceedings), pp.252-258, 1998 and “Evolutionary Optimization of Parameter Sets for Adaptive Software-Agent Traders in Continuous Double-Auction Markets”, Technical Report HPL-2001-99, Hewlett-Packard Laboratories.

This use of automated trading agents is implemented within a specific market mechanism (i.e. the type of auction the traders are interacting within) that is fixed in advance of the GA optimising the specific market mechanisms parameter values. Examples of well known market mechanisms include the english auction (where sellers stay silent and buyers quote increasing bid-prices), the dutch flower auction (where buyers stay silent and sellers quote decreasing offer-prices), the Vickery or second-price sealed-bid auction (where sealed bids are submitted by buyers, and the highest bidder is allowed to buy, but at the price of the second-highest bid); and the CDA (where sellers announce decreasing offer prices while simultaneously and asynchronously the buyers announce increasing bid prices, with the sellers being free to accept any buyers bid at any time and the buyers being free to accept any seller's offer at any time).

### SUMMARY OF THE INVENTION

In accordance with a first aspect of the present invention there is provided a computer apparatus for designing a market mechanism comprising means for defining a space of possible market mechanisms; a processor arranged to select a market mechanism within the continuum of market mechanism.

Preferably the space of possible market mechanisms is defined as a continuum.

Preferably the continuum of market mechanisms is defined by probability of a seller making a quote equal 100% minus the probability of a buyer making a bid.

Preferably the processor is arranged to select a market mechanism within the continuum of market mechanisms to provide optimisation of a market dynamic.

Preferably the market dynamic is the maximisation of the difference between an accepted quote or bid and a trader's price limit.

Preferably the processor is arranged to select the market mechanism using an optimisation algorithm.

Preferably the optimisation algorithm is a genetic algorithm.

In accordance with a second aspect of the present invention there is provided a method for designing a market mechanism comprising defining a space of possible market mechanisms; selecting a market mechanism within the continuum of market mechanisms.

In accordance with a third aspect of the present invention there is provided a computer apparatus comprising a processor for being arranging as an artificial trading agent; the processor being arranged to define a space of possible market mechanisms; the processor being arranged to select a market mechanisms within the continuum of market mechanisms using a optimisation algorithm to provide optimisation of a market dynamic for the artificial trading agent.

In accordance with a fourth aspect of the present invention there is provided a computer apparatus comprising a processor for being arranging as a number of artificial trading agents; the processor being arranged to define a space of possible market mechanisms; the processor being arranged to select a market mechanisms within the continuum of market mechanisms using a optimisation algorithm to provide optimisation of a market dynamic for the artificial trading agents.

The continuum of market mechanisms is continuously variable, thereby allowing for any of an infinite number of auction types to be evolved, which have no known correlate in naturally-occurring market mechanisms. While there is nothing to prevent the genetic algorithm from settling on solutions that correspond to market mechanisms similar to the known auction types of english auction EA, dutch flower auction DFA, or continuous double auction CDA, hybrid solutions can lead to the most desirable market dynamics. These selected market mechanisms can be implemented in online electronic marketplaces, even though they have not been designed by humans: rather they are the product of evolutionary search through the continuous space of possible auction-types. This allows market mechanisms for artificial traders to be designed by automatic means.

### BRIEF DESCRIPTION OF THE DRAWINGS

For a better understanding of the present invention and to understand how the same may be brought into effect reference will now be made, by way of example only, to the accompanying drawings, in which:

FIG. 1 illustrates a market place suitable for implementing an embodiment of the present invention;

FIG. 2 shows supply and demand schedules for a first market;

FIG. 3 shows fitness values for an evolving market mechanism for the first market;

FIG. 4 shows fitness values for a non-evolving market mechanism for the first market;

FIG. 5 shows comparison of an evolving market mechanism and a non-evolving market mechanism for the first market;

FIG. 6 shows supply and demand schedules for a second market;

FIG. 7 shows comparison of an evolving market mechanism and a non-evolving market mechanism for the second market;

FIG. 8 shows supply and demand for a third market;

FIG. 9 shows comparison of an evolving market mechanism and a non-evolving market mechanism for the third market;

FIG. 10 shows evolutionary trajectory of the market mechanism for the first market;

FIG. 11 shows evolutionary trajectory of the market mechanism for the second market;

FIG. 12 shows evolutionary trajectory of the market mechanism for the third market;

FIG. 13 shows evolutionary trajectory of the learning rate of the market mechanism for the third market.

### DETAILED DESCRIPTION OF PREFERRED EMBODIMENTS OF THE PRESENT INVENTION

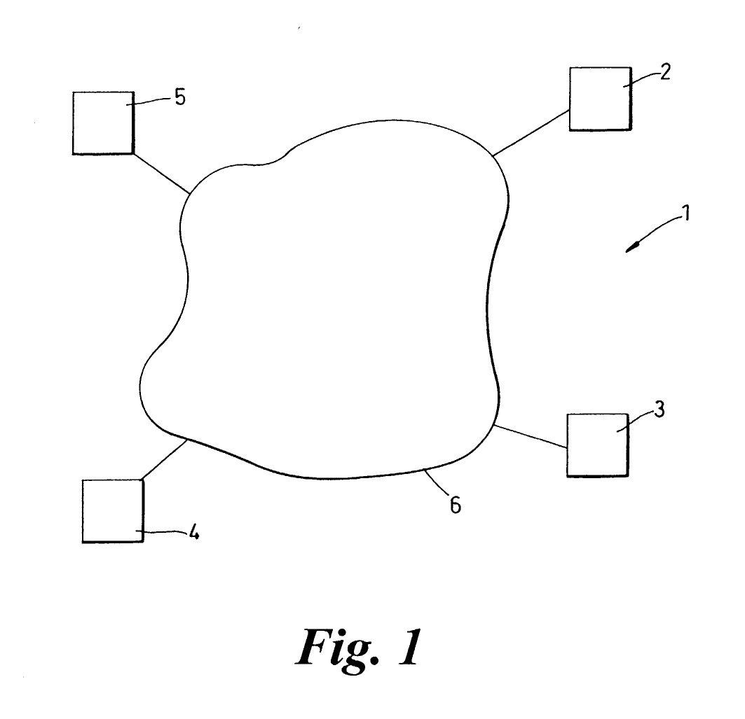

FIG. 1 shows a market place 1 having four automated trading agents 2-5 that are arranged to trade. It should be noted, however, that the market place 1 may have any number of traders. In this embodiment each automated trading agent 2-5 is a software agent running on a conventional computer and communicate via the internet 6, however any suitable means for communicating may be used and can involve a third party (not shown) for regulating the trading.

Each automated trading agent 2-5 is given a private (secret) limit-price, λ, which when the automated trading agent is acting as a seller is the price below which the trader must not sell and when the automated trading agent is a buyer is the price above which the trader must not buy. If an automated trading agent completes a transaction at its λ price then it generates zero utility (i.e. “profit” for the sellers or “saving” for the buyers). For this reason, each automated trading agent 2-5 maintains a time-varying margin μ(t) and generates quote-prices p(t) at time t according to p(t)=λ(1+μ(t)) for sellers and p(t)=λ (1−μ(t)) for buyers. The “aim” of traders is to optimise market dynamics, for example maximise their utility over all trades, where utility is the difference between the accepted quote-price and the trader's λ value or minimise fitness value, where fitness is the difference between transaction price and the theoretical equilibrium price. Each automated trading agent 2-5 is given an initial value μ(0) (i.e., μ(t) for t=0) which is subsequently adapted over time using a machine learning technique, for example the Widrow-Hoff rule. This rule has a “learning rate” parameter β that governs the speed of convergence for each automated trading agent's 2-5 quoted price p(t) and the trader's idealised “target” price τ(t). For the purposes of this embodiment when calculating τ(t), traders 2-5 introduce a small random absolute perturbation v generated from U[0, cₐ], and also a small random relative perturbation generated from U[1−cᵣ, 1+cᵣ] where cₐ and cᵣ are system constants. To smooth over noise in the learning system, there is an additional “momentum” parameter γᵢ for each trader 2-5. It should be noted that v=U[x, y] is used to denote a random value v generated from a uniform distribution over the real number range from x to y.

Thus, adaptation in each automated trading agent 2-5 has the following parameters: initial margin μ(0); learning rate β; and momentum term γ. In an entire market populated by automated trading agents, these three parameters are assigned to each trader from uniform random distributions each of which is defined via “min” and “delta” values in the following fashion: μ(0)=U(μₘᵢₙ, μₘᵢₙ+μ_{Δ}); β=U(βₘᵢₙ, βₘᵢₙ+β_{Δ}); and γ=U(γₘᵢₙ, γₘᵢₙ+γ_{Δ}). Hence, to initialise an entire automated trading agent market it is necessary to specify values for the six market initialisation parameters μₘᵢₙ , μ_{Δ}, β_{min,} β_{Δ}, γₘᵢₙ , and γ_{Δ}; and also for the two perturbation system constants cₐ and cᵣ. And so it can be seen that, for this embodiment, any set of initialisation parameters for a automated trading agent market exists within an eight-dimensional real space, however other parameters can be chosen. Vectors in this 8-space can be considered as genotypes, and from an initial population of such genotypes it is possible to allow a GA to find new genotype vectors that best satisfy an appropriate evaluation function.

In the automated trading agent markets described below, a time-slicing approach is used where in each time-slice, an atomic “significant event” is one quote being issued by one trader and the other traders then responding either by ignoring the quote or by one of the traders accepting the quote.

In each time-slice an automatic trading agent 2-5 is chosen at random from those currently able to quote (i.e. those who hold appropriate stock or currency), and the trader's 2-5 quote price p(t) becomes the “current quote” q(t) for time t. Then all other automated trading agents on the contra side (e.g. if the chosen automated trading agent 2 is a seller then the contra side agents 3-5 will be buyers) compare q(t) to their own current quote price p(t) and if it is “favourable” (i.e. if p(t)<=q(t) for sellers, or if p(t)>=q(t) for buyers) then the appropriate contra side automated trading agent is able to accept the quote. If one or more traders are able to accept, one of those traders is chosen at random to make the transaction. If no traders are able to accept, the quote is regarded as “ignored”. Once the trade is either accepted or ignored, the traders update their μ(t) values using the learning algorithm outlined above, and the current time-slice ends. This process repeats for each time-slice, usually with occasional injections of fresh currency or stock, or redistribution of λ limit prices, until a predetermined number of time-slices has completed.

The market mechanism (i.e. auction mechanism) can be defined by the probabilities of a buyer or seller submitting a bid or quote respectively, for example a CDA there is a 50% probability of either a buyer or a seller making a bid or quote respectively (i.e. probability of a buyer making a bid is 50% Pr(Q=b)=0.5 and the probability of a seller making a quote is 50% Pr(Q=s)=0.5).

By establishing the space of possible market mechanisms by the equation:

Probability of a seller making a quote (Pr(Q=s)) equals 100% minus the probability of a buyer making a bid (Pr(Q=b)) (i.e. Pr(Q=s)=1.0−Pr(Q=b))

a continuous variable space of market mechanisms is defined allowing for any infinite number of hybrid market mechanisms to be selected. Obviously, however, the equation Pr(Q=s)=1.0−Pr(Q=b) can be represented in other ways (e.g. Pr(Q=b)=1.0−Pr(Q=s)). Although the one-dimensional space associated with the market mechanism is continuously variable other dimensional variations associated with the market need not be continuous.

By including the market mechanism as a market parameter we add a ninth dimension to our search space, and the genotype is now the eight real values governing the automated trading agent initialisation, plus a real value representing Pr(Q=b).

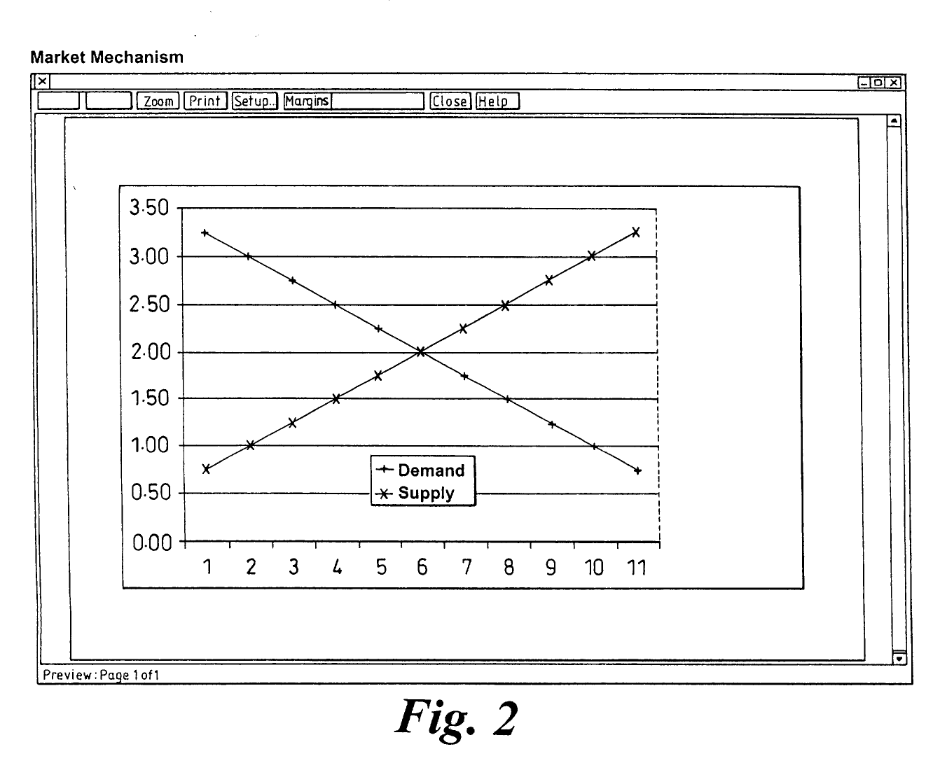

To allow optimisation of the market dynamics associated with the nine dimension market a optimisation algorithm (e.g. genetic algorithm) is used. FIGS. 2-13 show the results of the optimisation of three markets using a genetic algorithm using a population of size 30 and allowing evolution to progress for 1000 generations. In each generation each individual within the population is evaluated and assigned a fitness values (i.e. the difference in transaction price with the theoretical equilibrium price); and the next generation's population is then generated via mutation and crossover on parents identified using rank-based selection, as is well known to a person skilled in the art.

The genome of each individual within the population is a vector of the nine real values that define the market. In each experiment, the initial random population is created by generating random values from U[0, 1] for each locus on each individual's genotype. Crossover points were between the real values, and crossover was governed by a Poisson random process with an average of between one and two crosses per reproduction event. Mutation is implemented by adding random values from U[−m(g),+m(g)] where m(g) is the mutation limit at generation g (starting the count at g=0). Mutation is applied to each locus in each genotype on each individual generated from a reproduction event, but the mutation limit m(g) was gradually reduced via an exponential-decay annealing function of the form: log₁₀(m(g))=−(log₁₀(mₛ)−(g/(n_{g}−1)) log₁₀(mₛ/mₑ)) where n_{g} is the number of generations (here n_{g}=1000) and mₛ is the “start” mutation limit (for m(0)) and mₑ is the “end” mutation limit (for m(n_{g})). In all the experiments reported here, mₛ=0.05 and mₑ=0.0005.

For each of the experiments if mutation caused the value at a locus to fall outside [0, 1] it was simply clipped to stay within range. Moreover, initial and mutated genome values of μ_{Δ}, β_{Δ}, and γ_{Δ} were clipped where necessary to satisfy the constraints (μₘᵢₙ+μ_{Δ})<=1.0, (βₘᵢₙ+β_{Δ})<1.0, and (γₘᵢₙ+γ_{Δ})<1.0.

The fitness of genotypes was evaluated using the methods described in “Genetic Optimization of Adaptive Trading Agents for Double-Auction Markets'” in Proceedings of the 1998 Conference on Computational Intelligence for Financial Engineering (CIFEr98) IEEE/IAFE/Informs (preprint proceedings), pp.252-258, 1998 and “Evolutionary Optimization of Parameter Sets for Adaptive Software-Agent Traders in Continuous Double-Auction Markets”, Technical Report HPL-2001-99, Hewlett-Packard Laboratories, however, other techniques can be used to evaluate fitness.

As minimal deviation of transaction prices from the theoretical equilibrium price is desirable, lower scores are better as the aim in these experiments was to minimise the fitness value (i.e. the market dynamic that is being optimised is the fitness value).

In each experiment the 30 individuals of the population are evaluated over 1000 generations where each evaluation involves calculating the mean of 100 trials, therefore a total of 3 million market trials are executed in any one GA experiment. Additionally, to generate reliable results each experiment was repeated 50 times (i.e., 150 million market trials, approx. 250 hours).

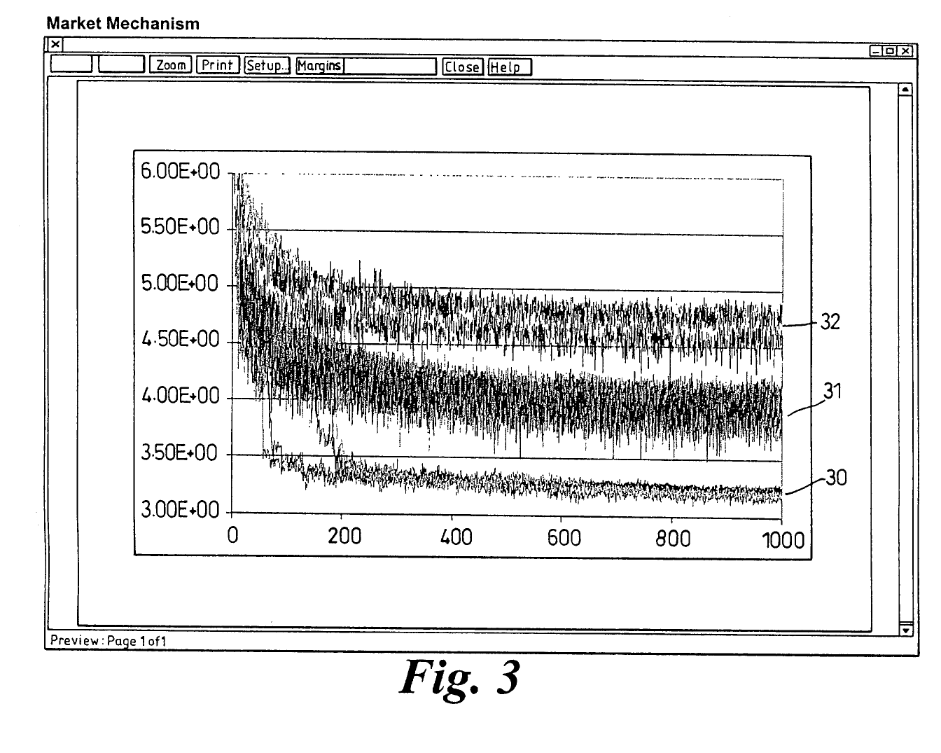

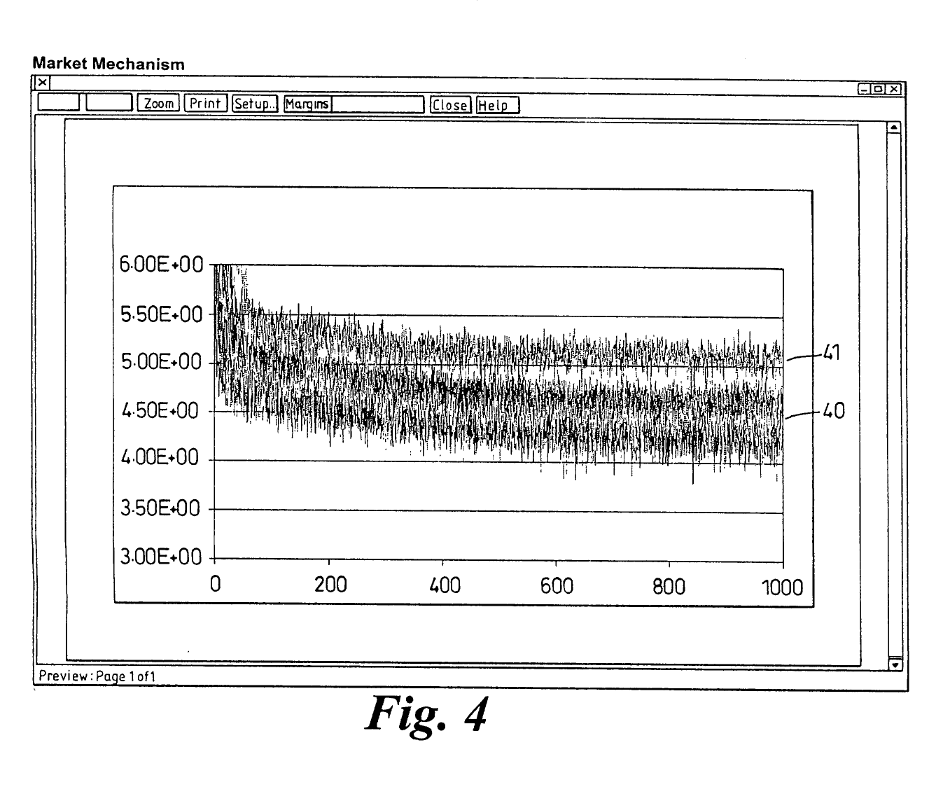

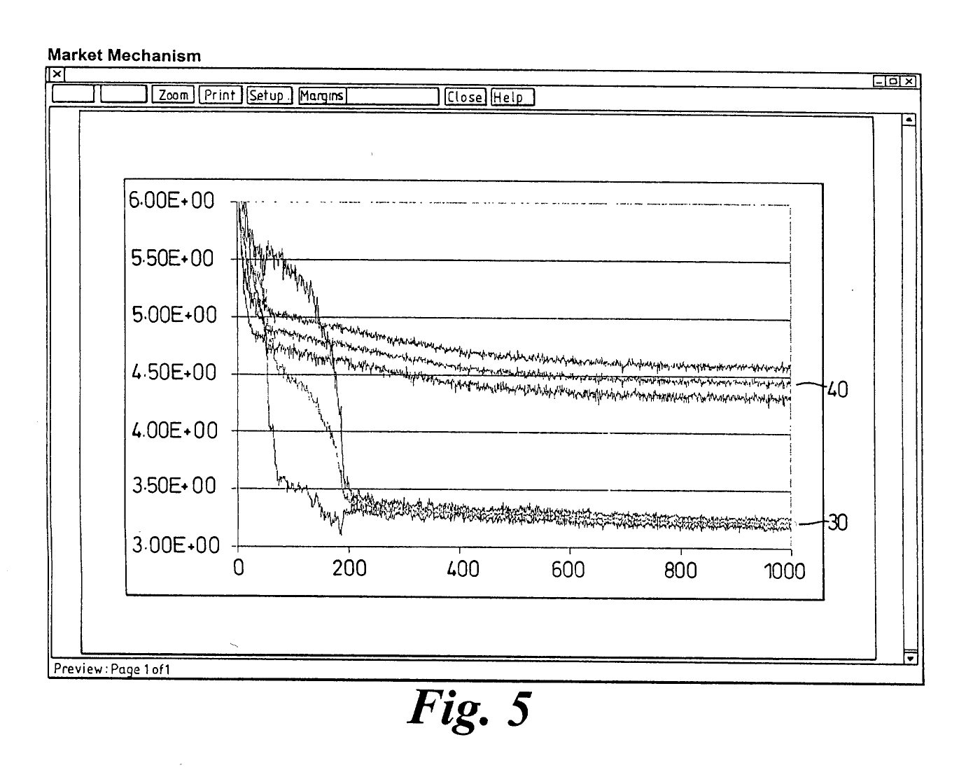

FIG. 2 shows a supply and demand schedule for a first market with 11 buyers and 11 sellers. FIG. 3 shows the results from fifty repetitions of an experiment where the GA explores the 9-dimensional space. The results are tri-modal. Of the fifty repetitions one mode 30 of five runs end up on fitness minima of approx 3.2, while the other two modes 31, 32 are on less-good minima of approx. 4.0 and 4.75. FIG. 4 shows the results of fifty repeats of the same experiment, where the value of Pr(Q=b) was not evolved, being instead clamped at 0.5: i.e. the CDA value. The results are bi-modal. With no evolution of auction style, an average fitness of around 4.5 is settled on by the majority of experiments (48 repetitions) at one mode 40 while a small minority (2 repetitions) settle on a less good mode 41 of around 5.1. FIG. 5 shows the fitness data for the best mode 30 from FIG. 3 (evolution of market mechanism) and the best mode 40 from FIG. 4 (no evolution of market mechanism).

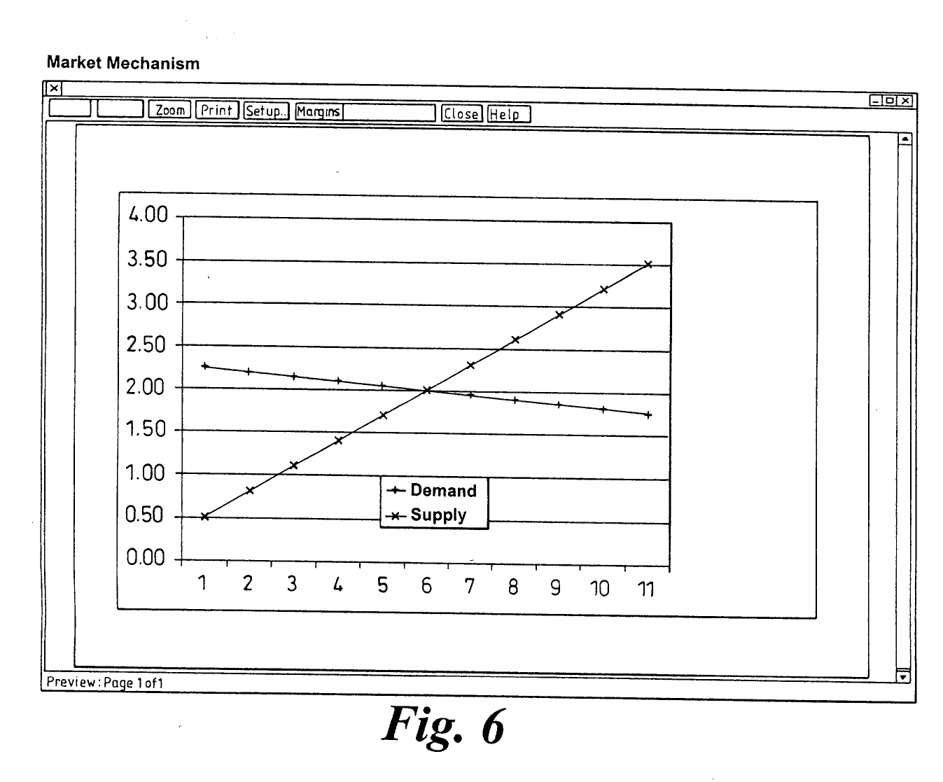

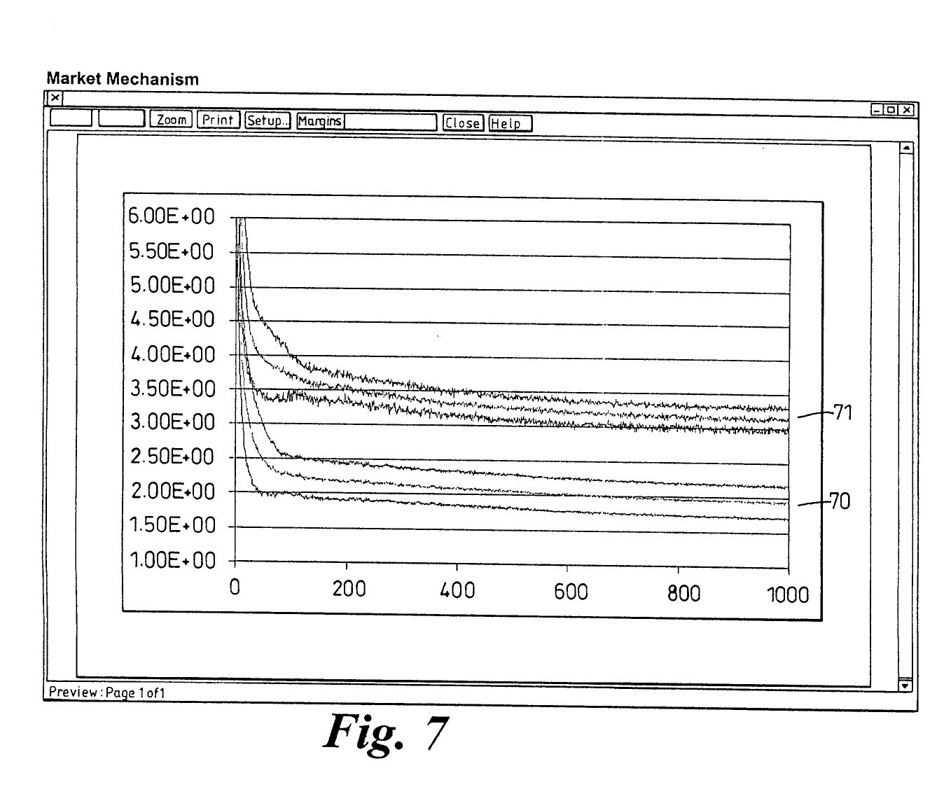

FIG. 6 shows a second market with a second supply and demand schedule to that in FIG. 1, with 11 buyers and 11 sellers. FIG. 7 shows comparison of the mean scores from the best mode 70 of fifty repetitions of an evolving-market experiment and the best mode 71 of fifty repetitions of a fixed-market experiment for the second market. Evolving-market fitnesses settle to a mean of just under 2.0 with a standard deviation of approx 0.2; fixed-market fitnesses settle to a mean of around 3.1 with a standard deviation of approx. 0.15.

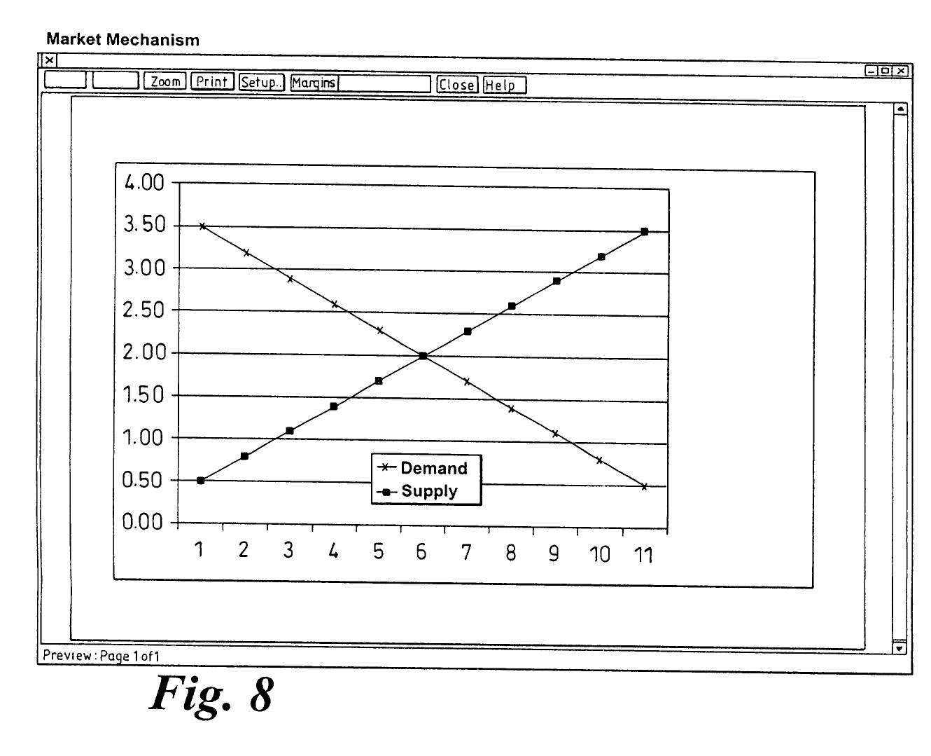

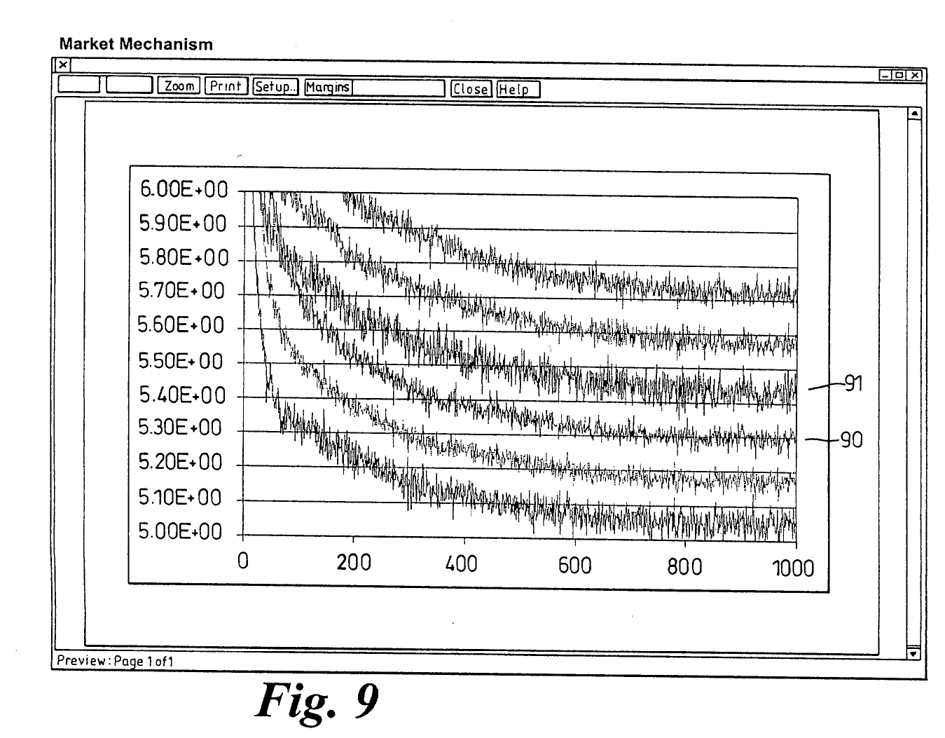

FIG. 8 shows a third market with a third supply and demand schedule with 11 buyers and 11 sellers. FIG. 9 shows comparison of the mean scores from the best mode 90 of fifty repetitions of an evolving-market experiment and the best mode 91 of fifty repetitions of a fixed-market experiment for the third market. Evolving-market fitness's settle to a mean of just under 5.3 with a standard deviation of approx 0.12; fixed-market fitness's settle to a mean of around 5.5 with a standard deviation of approx. 0.15.

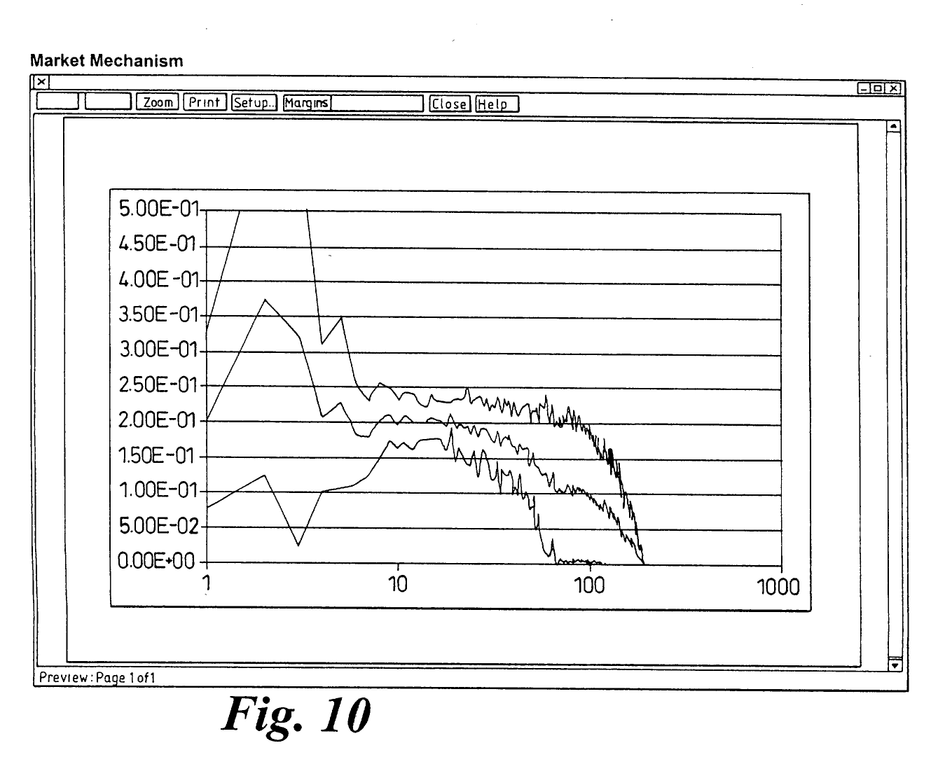

FIG. 10 shows the evolutionary trajectory of mean (plus and minus one standard deviation) value of Pr(Q=b) in the first market where the best fitness mode settles on a Pr(Q=b) of 0.0.

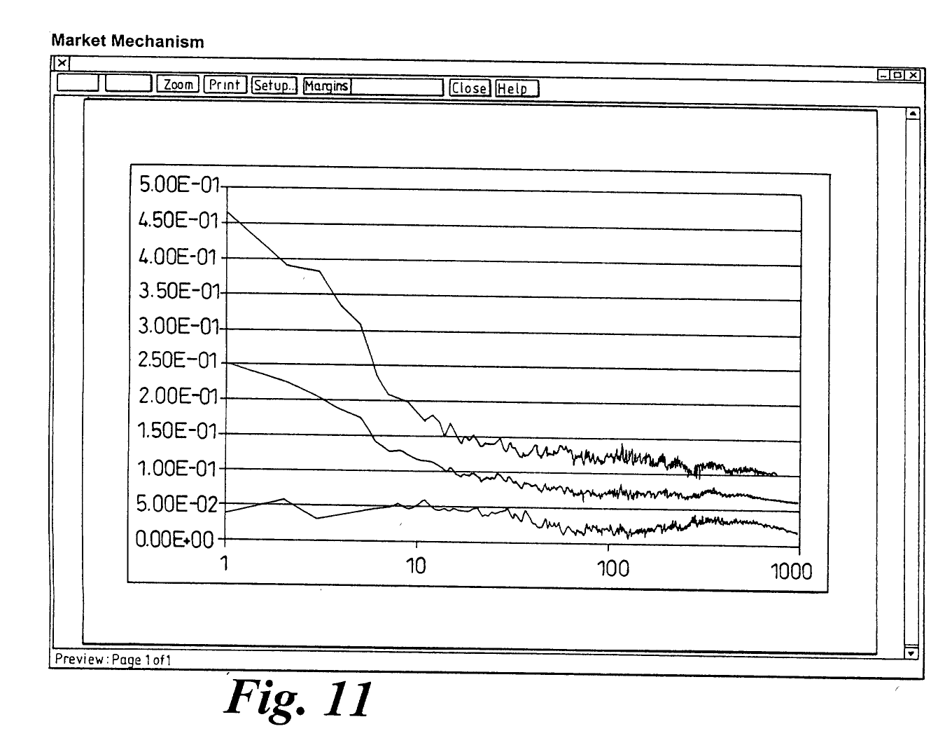

FIG. 11 shows the evolutionary trajectory of mean (plus and minus one standard deviation) value of Pr(Q=b) in the second market, where the best fitness mode settles on a Pr(Q=b) of a little over 0.05.

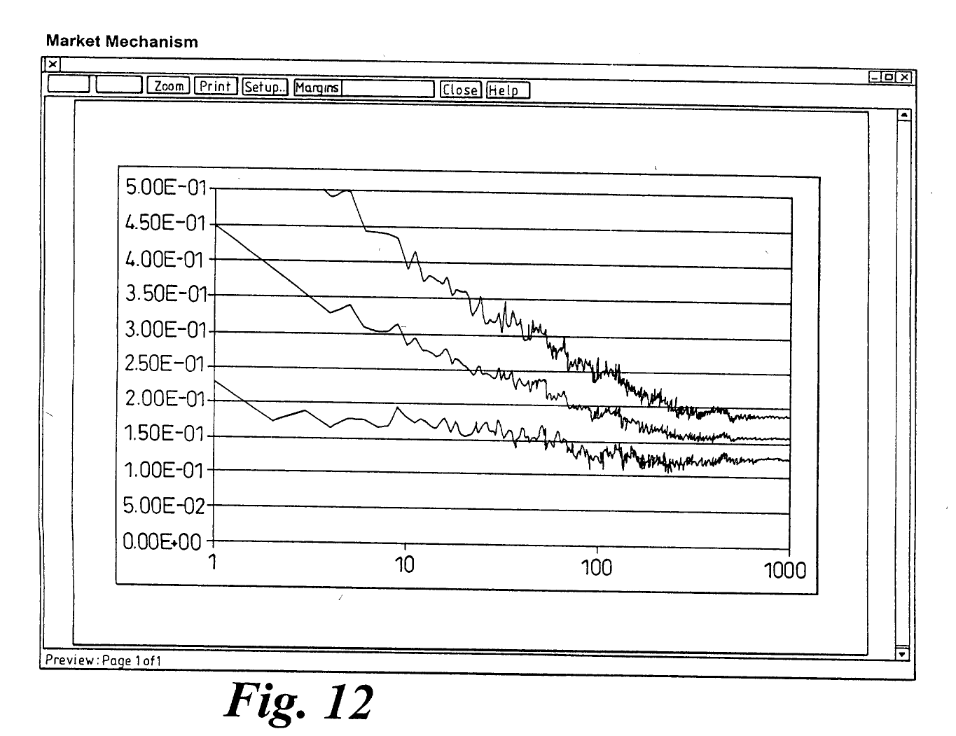

FIG. 12 shows the evolutionary trajectory of mean (plus and minus one standard deviation) value of Pr(Q=b) in the third market, where the best fitness mode settles on a Pr(Q=b) of a little over 0.15.

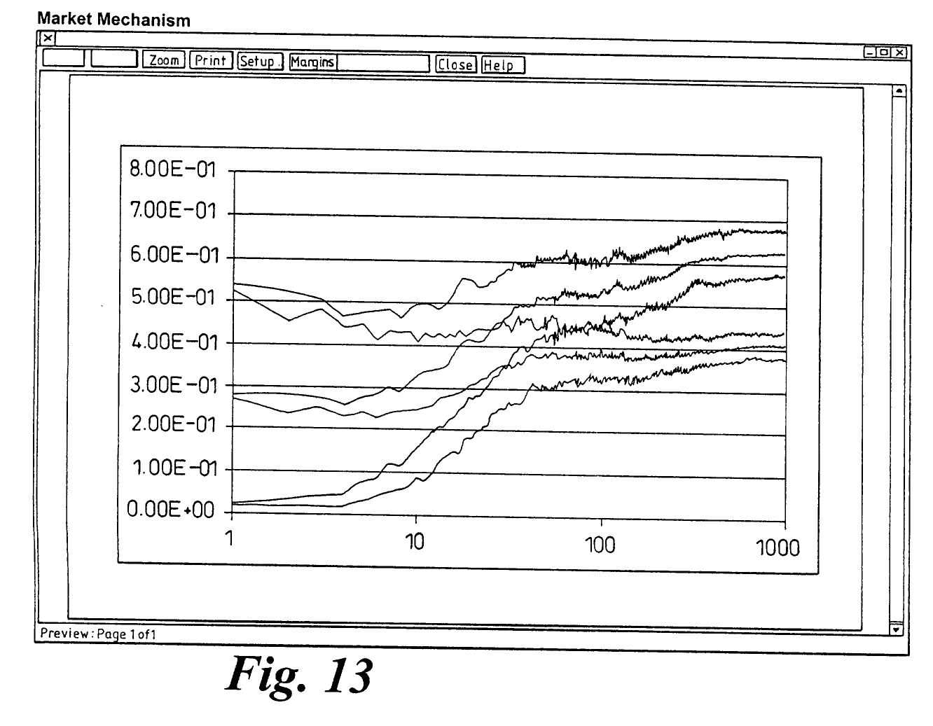

FIG. 13 shows how the average βₘᵢₙ values (i.e., the lower bound on the traders' learning rates) in the third markets two sets compare. The values of βₘᵢₙ appropriate for the fixed CDA market are significantly higher than the values found to give most fitness in the evolving-market case. Fixed-market values settle on a mean of around 0.62 while evolving-market values settle on a mean of approx 0.4.

What is claimed:

1. Computer apparatus for designing a market mechanism comprising means for defining a space of possible market mechanisms; a processor arranged to select a market mechanism within the space of market mechanism.

2. Computer apparatus according to claim 1, wherein the space of possible market mechanisms defines a continuum of market mechanism.

3. Computer apparatus according to claim 2; wherein the continuum of market mechanisms is defined by probability of a seller making a quote equals 100% minus the probability of a buyer making a bid.

4. Computer apparatus according to claim 1; wherein the processor is arranged to select a market mechanism within the space of possible market mechanisms to provide optimisation of a market dynamic.

5. Computer apparatus according to claim 4, wherein the market dynamic is the minimization of the deviation of transaction prices from a markets theoretical equilibrium price.

6. Computer apparatus according to claim 1, wherein the processor is arranged to select the market mechanism using an optimisation algorithm.

7. Computer apparatus according to claim 5, wherein the optimisation algorithm is a genetic algorithm.

8. Method for designing a market mechanism comprising defining a space of possible market mechanisms; selecting a market mechanism within the space of possible market mechanisms.

9. Method for designing a market mechanism according to claim 8, wherein the space of possible market mechanisms defines a continuum of market mechanisms.

10. Method for designing a market mechanism according to claim 9, wherein the continuum of market mechanisms is defined by probability of a seller making a quote equals 100% minus the probability of a buyer making a bid.

11. Method for designing a market mechanism according to claim 8, further comprising selecting the market mechanism using an optimisation algorithm.

12. Computer apparatus comprising a processor for being arranged as an artificial trading agent; the processor being arranged to define a space of possible market mechanisms; the processor being arranged to select a market mechanisms within the continuum of market mechanisms using a optimisation algorithm to provide optimisation of a market dynamic for the artificial trading agent.

13. Computer apparatus according to claim 12, wherein the optimisation algorithm is a genetic algorithm.

14. Computer apparatus comprising a processor for being arranged as a number of artificial trading agents; the processor being arranged to define a space of possible of market mechanisms; the processor being arranged to select a market mechanisms within the continuum of market mechanisms using a optimisation algorithm to provide optimisation of a market dynamic for the artificial trading agents.
